(19) United States
(12) Patent Application Publication
(10) Pub. No.: US 2022/0127173 A1
(43) Pub. Date: Apr. 28, 2022

(54) SYSTEM AND METHOD FOR TOTAL VOLUME TREATMENT OF LANDFILL LEACHATE AND USE THEREOF

(71) Applicant: Northwest A&F University, Xianyang (CN)

(72) Inventors: Guangzhou Qu, Xianyang (CN); Zhi Jiao, Xianyang (CN); Lang Xia, Xianyang (CN); Zhentai Zhang, Xianyang (CN); Zengqiang Zhang, Xianyang (CN)

(21) Appl. No.: 17/335,048

(22) Filed: May 31, 2021

(30) Foreign Application Priority Data
Oct. 26, 2020 (CN) 202011158322.0

(51) Int. Cl. C02F 3/12; C02F 11/00; C02F 11/02

(52) U.S. Cl. CPC C02F 3/1268; C02F 2103/06; C02F 11/02; C02F 11/006

(57) ABSTRACT

The present disclosure belongs to the technical field of treating landfill leachate, and in particular to a system and a method for total volume treatment of landfill leachate, and a use thereof. The system comprises an integrated device of dielectric barrier discharge combined with catalyst treatment, an SBR-MBR biochemical treatment device and a PLC control device; the integrated device for a discharge barriered by dielectric and a catalysis treatment is communicated with the SBR-MBR biochemical treatment device through a water transport pipeline, and the PLC control device is respectively connected with the integrated device for a discharge barriered by dielectric and a catalysis treatment and the SBR-MBR biochemical treatment device through connecting lines.

### CROSS REFERENCE TO RELATED APPLICATION

This patent application claims the benefit and priority of Chinese Patent Application No. 202011158322.0 filed on Oct. 26, 2020, the disclosure of which is incorporated by reference herein in its entirety as part of the present application.

### TECHNICAL FIELD

The present disclosure belongs to the technical field of treating landfill leachate, and in particular to a system and a method for total volume treatment of landfill leachate, and a use thereof.

### BACKGROUND ART

Landfill leachate is a high-concentration wastewater which is formed from the moisture contained in the garbage in the landfill, rain, snow and other moisture entering the landfill, deducting the saturated water holding capacity of the garbage and covering soil layer, after passing through the garbage layer and covering soil layer. Influenced by many factors such as garbage composition, landfill time, climatic conditions, this kind of wastewater comprises very complex components, contains many kinds of organic pollutants, and is generally characterized by “three highs”, namely, high COD, high ammonia nitrogen content and high salinity. In addition, most landfill leachate contains a variety of heavy metal ions, a serious imbalanced microbial nutrition such as C, N and P, and has a poor biodegradability, great changes in water quality, a dark color and a foul smell. These characteristics make the treatment of landfill leachate a very difficult problem.

The construction of a plant for treating landfill leachate in China began in 1990s, and the treatment of landfill leachate has gone through three stages. The first stage: in the early 1990s, the treatment process mainly referred to a method for treating the municipal sewage, and mainly adopted “pretreatment+aerobic biological treatment” process (such as flocculation, sedimentation+activated sludge process); the second stage: in the middle and late 1990s, with further understanding of the water quality of landfill leachate, considering the unique water qualities of leachate, such as high-concentration ammonia nitrogen, high-concentration organics, deamination measures were taken, and the “pretreatment+anaerobic biological treatment+aerobic biological treatment” process was generally adopted, and most of the treatments were to meet the requirements for entering municipal sewage treating plants, namely the third-level standard in Table 1 of “Standard for Pollution Control on the Landfill Site of Municipal Solid Waste” (GB 16889-1997); the third stage: after 2000, the newly-built plants for treating leachate were generally far away from the urban areas, which makes it impossible to discharge the leachate into the urban sewage pipe network, and the standard for discharging leachate became stricter, which was required to meet the secondary or even primary discharging standard in Table 1 of “Standard for Pollution Control on the Landfill Site of Municipal Solid Waste” (GB 16889-1997), and thereby the “pretreatment+anaerobic biological treatment+aerobic biological treatment” process could no longer meet the discharging requirements, and people began to try the “pretreatment+biological treatment+advanced treatment” process. After 2008, a further stricter “Standard for Pollution Control on the Landfill Site of Municipal Solid Waste” (GB 16889-2008) was issued in China, which stipulated that both existing and newly built landfill sites of domestic waste should be equipped with relatively complete facilities for treating sewage, and leachate after treating was required to meet the discharging limit specified in the standard before being directly discharged, which further promoted the upgrading of existing technologies, and the research and development and industrial application of new technologies.

At present, a “pretreatment+biological treatment+advanced treatment” process is widely used in projects for treating landfill leachate, in which “pretreatment+biological treatment+double membrane (nanofiltration+reverse osmosis) treatment” process has become the mainstream combined process. This process solves the problems present in the advanced treatment of a large number of non-degradable substances and toxic substances contained in leachate, and could provide effluent with a good quality, which can meet the emission standards. However, this process has a fatal defect in technology, i.e., its effluent rate is less than 75%, and it will produce more than 25% concentrated wastewater, which is a wastewater with a much higher salt content, chroma, ammonia nitrogen content, total nitrogen content and COD, and is much more difficult to treat. In view of the concentrated wastewater produced by “double membrane” treatment, some recharge the concentrated solution to the landfill site, and thus the pollutants will return to the landfill leachate, but with the continuous accumulation of pollutants, the system will eventually collapse; some adopt evaporation and crystallization process, but its investment and operation cost are too high, which is not feasible in practical implement. In addition, the “double membrane” treatment still has some disadvantages, such as membrane pollution, blockage, complex in operation and management, large in investment, high in operation cost.

It can be seen from the above analysis that the existing problems and defects in the prior art are as follows: the effluent rate of “double membrane” treatment is low, which produces a concentrated wastewater that is much more difficult to treat, and the “double membrane” treatment still has some disadvantages, such as membrane pollution, blockage, complex in operation and management, large in investment, and high in operation cost.

There are some difficulties in solving the above problems and defects: the process of “double membrane” treatment inevitably produces a concentrated wastewater, and thus the total volume treatment of landfill leachate could not be realized, which is the technical bottleneck that the process could not break through; membrane pollution and blockage refers to that the pores of the membrane become smaller and smaller or are blocked due to the adsorption and deposition of particles, colloidal particles or solute macromolecules in water on the membrane surface or pores caused by physical-chemical interactions or mechanical actions between the above particles, colloidal particles or solute macromolecules in water and membrane during membrane filtration, leading to irreversible changes in permeation flow and separation characteristics of the membrane; the service life of the membrane could only be prolonged through frequent and complex cleaning processes, which inevitably leads to problems such as complex in operation and management, large in investment, and high in operation costs, which are also insurmountable by this process.

The significance of solving the above problems and defects is as follows: if the “double membranes” treatment in the “advanced treatment” process could be replaced to realize the discharge of total volume landfill leachate that is up to standard, there will be no problems of concentrated wastewater, membrane pollution and blockage, which will greatly reduce the cost of treating landfill leachate and promote the healthy and long-term development of China's garbage treatment industry.

### SUMMARY

To address the problems existing in the prior art, the present disclosure provides a system and a method for total volume treatment of landfill leachate, and a use thereof.

The objects of present disclosure are achieved by the following technical solutions:

The present disclosure provides a system for total volume treatment of landfill leachate, comprising:

an integrated device of dielectric barrier discharge combined with catalyst treatment, an SBR-MBR biochemical treatment device and a PLC control device; wherein

the integrated device of dielectric barrier discharge combined with catalyst treatment is communicated with the SBR-MBR biochemical treatment device through a water transport pipeline, and the PLC control device is connected with the integrated device of dielectric barrier discharge combined with catalyst treatment and the SBR-MBR biochemical treatment device through connecting lines, respectively.

In some embodiments, the connecting lines are transmission lines.

In some embodiments, the integrated device of dielectric barrier discharge combined with catalyst treatment is provided with a reaction tank, the reaction tank is internally provided with a discharge-catalysis reactor and a catalyst supporting net filled with a catalyst below the discharge-catalysis reactor, and is communicated with a gas-liquid separation tank through a water transport pipeline, wherein the gas-liquid separation tank is communicated with a tail gas quencher through a gas transport pipeline;

the discharge-catalysis reactor is communicated with a gas source through a gas transport pipeline, and the gas source is communicated with the PLC control device through a connecting line;

the discharge-catalysis reactor is connected with a high-voltage power supply through a connecting line, and the high-voltage power supply is connected with the PLC control device through a connecting line.

In some embodiments, the reaction tank comprises a reaction tank body, a reaction tank body flange, a flange silica gel pad and a reaction tank base, wherein the reaction tank body flange is mounted at the upper end of the reaction tank body, and is padded with the flange silica gel pad thereon; the lower end of the reaction tank body is fixed on the reaction tank base, and the reaction tank base is arranged with a water inlet and a water outlet at the center, wherein the water inlet and the water outlet are respectively provided with a reaction tank water inlet control valve and a reaction tank water outlet control valve.

In some embodiments, the discharge-catalysis reactor comprises a reactor fixing frame, a discharge tube, a dielectric tube, an upper fixing plate, a lower fixing plate, an upper fixing plate gas hole, a lower fixing plate gas hole, an inlet gas chamber top cover, an inlet gas chamber top cover gas hole, an outlet gas chamber bottom cover, an outlet gas chamber, an outlet gas chamber bottom cover gas hole, an aeration plate, a stainless steel connecting pipe, a catalyst supporting net, a high-voltage wire, a conductive layer and an earth wire;

the reactor fixing frame is provided with a coaxial stainless steel round pipe and a stainless steel fixing frame flange installed at the upper end of the coaxial stainless steel round pipe, for fixing the discharge-catalysis reactor in the reaction tank body, and the surface of the stainless steel fixing frame flange is provided with a water discharge hole;

the upper end and the lower end of the coaxial stainless steel round pipe inside are provided with the upper fixing plate and the lower fixing plate, respectively, which are threadably secured thereon, respectively, the discharge tube is sandwiched between the upper fixing plate and the lower fixing plate, and a dielectric tube is sheathed with the discharge tube at the outside of the discharge tube;

the upper fixing plate and the lower fixing plate are provided with the upper fixing plate gas hole and the lower fixing plate gas hole, respectively, and the upper fixing plate gas hole and the lower fixing plate gas hole are communicated with the gap between the discharge tube and the dielectric tube;

the upper end inside the coaxial stainless steel round pipe is provided with the inlet gas chamber top cover which is threadably secured, and the inlet gas chamber is sandwiched between the inlet gas chamber top cover and the upper fixing plate, and the inlet gas chamber top cover is provided with the inlet gas chamber top cover gas hole, and the inlet gas chamber top cover gas hole is communicated with the gas source through a gas transport pipeline; the lower end inside the coaxial stainless steel round pipe is provided with the outlet gas chamber bottom cover which is threadably secured, and the outlet gas chamber is sandwiched between the outlet gas chamber bottom cover and the lower fixing plate; the outlet gas chamber bottom cover is provided with the outlet gas chamber bottom cover gas hole, and the lower end of the outlet gas chamber bottom cover gas hole is communicated with the aeration plate through a stainless steel connecting pipe, and the aeration plate is under the catalyst supporting net.

In some embodiments, the SBR-MBR biochemical treatment device is an integrated SBR-MBR biochemical treatment device, which consists of an integrated SBR-MBR reaction tank, a submerged MBR membrane module, an MBR pump and a sludge treatment device, wherein

the integrated SBR-MBR reaction tank is provided with a water inlet and a sludge discharge port, and also equipped with an SBR blower, an SBR aeration plate and an SBR sludge discharge pump;

the water inlet of the integrated SBR-MBR reaction tank is communicated with a gas-liquid separation tank water discharge control valve and a reaction tank water discharge control valve of the integrated device of dielectric barrier discharge combined with catalyst treatment, respectively; the SBR blower charges oxygen into the integrated SBR-MBR reaction tank through the SBR aeration plate arranged at the bottom of the integrated SBR-MBR reaction tank, and the SBR sludge discharge pump is communicated with the sludge discharge port of the integrated SBR-MBR reaction tank for regularly discharging excess sludge in the MBR reaction tank;

the submerged MBR membrane module is submerged in the integrated SBR-MBR reaction tank, and a water discharge pipe of the submerged MBR membrane module is communicated with the MBR pump for discharging a supernatant in the integrated SBR-MBR reaction tank;

the submerged MBR membrane module comprises a membrane selected from the group consisting of a hollow fiber membrane, a flat membrane, a ceramic membrane and so on.

the sludge treatment device is used for treating an excess sludge discharged from the integrated SBR-MBR reaction tank and consists of a sludge tank, a dosing tank, a stirrer and a pressure filter; the sludge tank is provided with a sludge inlet, a dosing port and a sludge discharge port, wherein the sludge inlet is communicated with the SBR sludge discharge pump, the dosing port is communicated with the dosing tank, the stirrer is located in the sludge tank for mixing reagents and the excess sludge, and the sludge discharge port is communicated with the pressure filter.

In some embodiments, the SBR-MBR biochemical treatment device is a split SBR-MBR biochemical treatment device, which consists of an SBR reaction tank, an MBR pump, an external MBR membrane module and a sludge treatment device;

the SBR reaction tank is provided with an SBR water inlet and an SBR sludge discharge port, and also equipped with an SBR blower, an SBR aeration plate, an SBR water decanter and an SBR sludge discharge pump;

the SBR water inlet is communicated with a gas-liquid separation tank water discharge control valve and a reaction tank water discharge control valve of the integrated device of dielectric barrier discharge combined with catalyst treatment, respectively; the SBR blower charges oxygen into the SBR reaction tank through the SBR aeration plate arranged at the bottom of the SBR reaction tank; the SBR water decanter is installed in the SBR reaction tank, and its water outlet is sequentially communicated with the MBR pump and the external MBR membrane module through a water transport pipeline; a supernatant in the SBR reaction tank is injected by the SBR water decanter into a water inlet of the external MBR membrane module through the MBR pump, and the water treated by the external MBR membrane is discharged from a water outlet of the external MBR membrane module; the SBR sludge discharge port is sequentially communicated with the SBR sludge discharge pump and the sludge treatment device through a sludge discharge pipeline, for regularly discharging the excess sludge in the SBR reaction tank;

the external MBR membrane module comprises a membrane selected from the group consisting of a tubular membrane and a column hollow fiber membrane;

the sludge treatment device is used to treat the excess sludge discharged from the SBR reaction tank and consists of a sludge tank, a dosing tank, a stirrer, and a pressure filter; the sludge tank is provided with a sludge inlet, a dosing port and a sludge discharge port, wherein the sludge inlet is communicated with the SBR sludge discharge pump, the dosing port is communicated with the dosing tank, the stirrer is located in the sludge tank for mixing regents and the excess sludge, and the sludge discharge port is communicated with the pressure filter.

In some embodiments, the PLC control device comprises outside a gas source control switch, a tail gas quencher control switch, a reaction tank-water inlet control valve control switch, a gas-liquid separation tank-water discharge control valve control switch, a high-voltage power supply control switch, an SBR blower control switch, an MBR pump control switch, an SBR sludge discharge pump control switch, a sludge treatment device control switch and a reaction tank-water discharge control valve control switch.

Another object of the present disclosure is to provide a method for totally treating landfill leachate by using the system for total volume treatment of landfill leachate, comprising:

(1) after connecting a connecting line, a water transport pipeline and a gas transport pipeline of the system, and filling the catalyst supporting net with a catalyst, turning on the gas source control switch and tail gas quencher control switch of the PLC control device in sequence, and introducing a gas in the gas source into the discharge-catalysis reactor of the integrated device of dielectric barrier discharge combined with catalyst treatment, and then discharging the gas into the gas-liquid separation tank from the water discharge hole of the reactor fixing frame through the reaction tank, and finally discharging the gas from an exhaust port of the gas-liquid separation tank and passing the gas through the tail gas quencher;

(2) turning on the reaction tank-water inlet control valve control switch and the gas-liquid separation tank-water discharge control valve control switch of the PLC control device, and injecting a pretreated and biologically treated landfill leachate into the reaction tank of the integrated device of dielectric barrier discharge combined with catalyst treatment;

(3) after filling the reaction tank with water, turning on the high-voltage power supply control switch of the PLC control device, inputting energy into the discharge-catalysis reactor by the high-voltage power supply, performing a discharge in the discharge-catalysis reactor to treat the landfill leachate, while performing a water inlet stage of the SBR biochemical treatment;

(4) after the water inlet stage of the SBR biochemical treatment process is completed, turning on the SBR blower control switch of the PLC control device to charge oxygen to the integrated SBR-MBR reaction tank or the split SBR reaction tank to start an aeration stage of the SBR biochemical treatment process; after the aeration stage is completed, turning off the SBR blower control switch of the PLC control device, thus starting a standing stage of the SBR biochemical treatment process; after the standing stage is completed, turning on the MBR pump control switch of the PLC control device to discharging water to start a water discharge stage; after the water discharge stage is completed, turning off the MBR pump control switch of the PLC control device; repeatedly running the water inlet stage, aeration stage, standing stage, and water discharge stage, during which when a sludge discharge is needed, turning on the SBR sludge discharge pump control switch of the PLC control device to discharge the sludge, and after the sludge is discharged completely, turning off the SBR sludge discharge pump control switch of the PLC control device.

Another object of the present disclosure is to provide a method for treating landfill leachate, comprising using the above system for total volume treatment of landfill leachate.

In the present disclosure, the total volume treatment of landfill leachate is a treatment of landfill leachate without concentrated wastewater.

For all the above technical solutions, the present disclosure has the advantages and positive effects as follows: in the present disclosure, the integrated device of dielectric barrier discharge combined with catalyst treatment could effectively decompose organic pollutants which are difficult to biodegrade in the landfill leachate without negative effects from factors such as water quality and water quantity, thereby improving the biodegradability of the landfill leachate; the SBR-MBR biochemical treatment device enables COD, BOD₅, nitrogen and phosphorus in the biodegradable landfill leachate to be removed; no concentrated solutions are produced during the whole process, thus realizing the total volume treatment of landfill leachate, and effectively overcoming the technical defects of membrane treatment of the landfill leachate, and has the advantages of a small investment, a low operation cost and the like; the PLC control device enables the operation, operation management of the whole process to be simple and reliable.

### BRIEF DESCRIPTION OF THE DRAWINGS

In order to more clearly illustrate the technical solutions according to the embodiments of the present disclosure, the accompanying drawings required in the embodiments of the present disclosure will be briefly introduced below, and obviously, the accompanying drawings described below are merely some embodiments of the present disclosure, and for a person of ordinary skill in the art, other drawings can be obtained according to the accompanying drawings without creative labor.

FIG. 1 shows a connection schematic diagram of a system for total volume treatment of landfill leachate with an integrated SBR-MBR biochemical treatment device according to embodiment(s) of the present disclosure.

FIG. 2 shows a connection schematic diagram of an integrated device of dielectric barrier discharge combined with catalyst treatment according to embodiment(s) of the present disclosure.

FIG. 3 shows a structural schematic diagram of a discharge-catalysis reactor according to embodiment(s) of the present disclosure.

FIG. 4 shows a structural schematic diagram of an upper fixing plate according to embodiment(s) of the present disclosure.

FIG. 5 shows a structural schematic diagram of a lower fixing plate according to embodiment(s) of the present disclosure.

FIG. 6 shows a connection schematic diagram of a system for total volume treatment of landfill leachate with a split SBR-MBR biochemical treatment device according to embodiment(s) of the present disclosure.

In the figures, 1 represents an integrated device of dielectric barrier discharge combined with catalyst treatment; 101 represents a reaction tank; 101-1 represents a reaction tank body; 101-2 represents a reaction tank flange; 101-3 represents a flange silica gel pad; 101-4 represents a reaction tank base; 101-5 represents a water inlet; 101-6 represents a water outlet; 102 represents a discharge-catalysis reactor; 102-1-1 represents a coaxial stainless steel round pipe; 102-1-2 represents a stainless steel fixing frame flange; 102-1-3 represents a water discharge hole; 102-2 represents a discharge tube; 102-3 represents a dielectric tube; 102-4 represents an upper fixing plate; 102-5 represents a lower fixing plate; 102-6 represents an upper fixing plate gas hole; 102-7 represents a lower fixing plate gas hole; 102-8 represents an inlet gas chamber top cover; 102-9 represents an inlet gas chamber; 102-10 represents an inlet gas chamber top cover gas hole; 102-11 represents an outlet gas chamber bottom cover; 102-12 represents an outlet gas chamber; 102-13 represents an outlet gas chamber bottom cover gas hole; 102-14 represents an aeration plate; 102-15 represents a stainless steel connecting pipe; 102-16 represents a catalyst supporting net; 102-17 represents a high-voltage wire; 102-18 represents a conductive layer; 102-19 represents an earth wire; 103 represents a catalyst; 104 represents a high-voltage power supply; 105 represents a gas source; 106 represents a gas-liquid separation tank; 107 represents a tail gas quencher; 2 represents an SBR-MBR biochemical treatment device; 201 represents an integrated SBR-MBR reaction tank; 202 represents a submerged MBR membrane module; 203 represents an MBR pump; 204 represents a sludge treatment device; 205 represents an SBR blower; 206 represents an SBR aeration plate; 207 represents an SBR sludge discharge pump; 208 represents an SBR water decanter; 3 represents a PLC control device; 301 represents a gas source control switch; 302 represents a tail gas quencher control switch; 303 represents a reaction tank-water inlet control valve control switch; 304 represents a gas-liquid separation tank-water discharge control valve control switch; 305 represents a high-voltage power supply control switch; 306 represents an SBR blower control switch; 307 represents an MBR pump control switch; 308 represents an SBR sludge discharge pump control switch; 309 represents a sludge treatment device control switch; 310 represents a reaction tank water discharge control valve control switch.

### DETAILED DESCRIPTION OF THE EMBODIMENTS

In order to make the object, technical solution and advantages of the present disclosure clearer, the present disclosure will be further described in detail with reference to the following embodiments. It should be understood that the specific embodiments described herein are only used to explain the present disclosure, and are not used to limit the present disclosure.

To address the problems existing in the prior art, the present disclosure provides a system and a method for the total volume treatment of landfill leachate and a use thereof. The present disclosure will be described in detail with reference to the accompanying drawings.

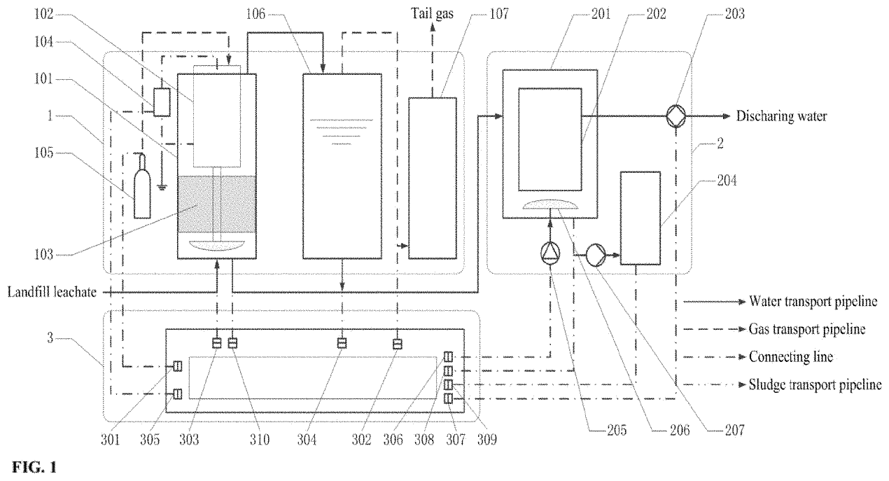

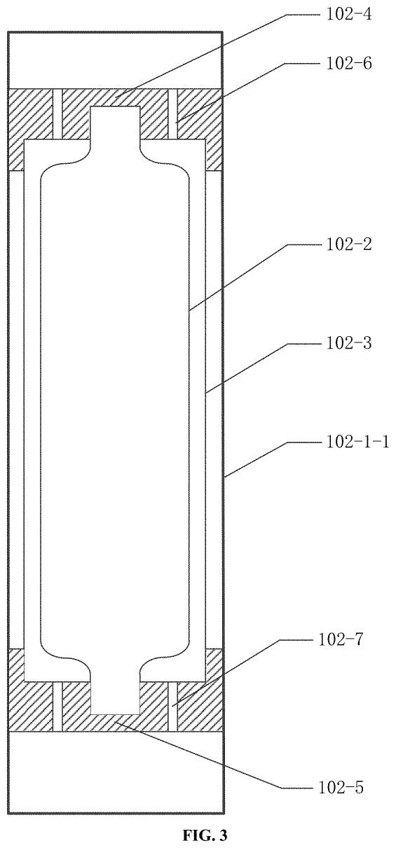

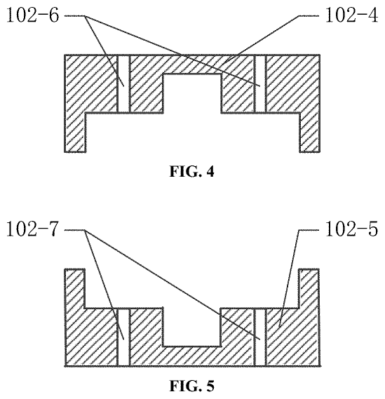

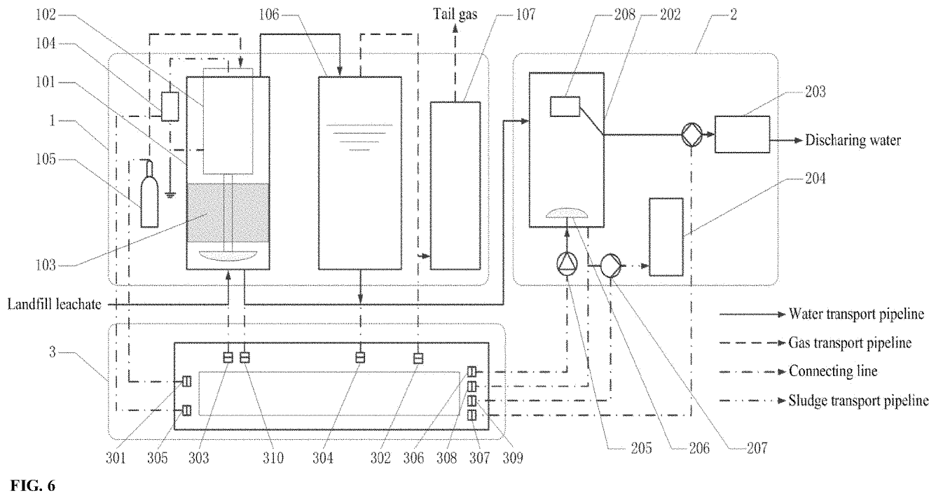

As shown in FIGS. 1 to 6, the system and method for total volume treatment of landfill leachate and the use thereof according to the embodiments of the present disclosure comprises an integrated device of dielectric barrier discharge combined with catalyst treatment 1, an SBR-MBR biochemical treatment device 2 and a PLC control device 3.

The integrated device of dielectric barrier discharge combined with catalyst treatment 1 consists of a reaction tank 101, a discharge-catalysis reactor 102, a catalyst 103, a high-voltage power supply 104, a gas source 105, a gas-liquid separation tank 106 and a tail gas quencher 107.

The reaction tank 101 is provided with a reaction tank body 101-1, which is an organic glass round tube with a height of 200 cm, an inner diameter of 26 cm and a wall thickness of 0.5 cm, and fixed on a reaction tank base 101-4 made of 316^{#} stainless steel through a flange and a silica gel pad; the reaction tank base 101-4 is provided with a water inlet 101-5 and a water outlet 101-6, which are equipped with a reaction tank water inlet control valve and a reaction tank water outlet control valve, respectively, and the reaction tank water inlet control valve and the reaction tank water outlet control valve are solenoid valves, the switches of which are controlled by the PLC control device 3.

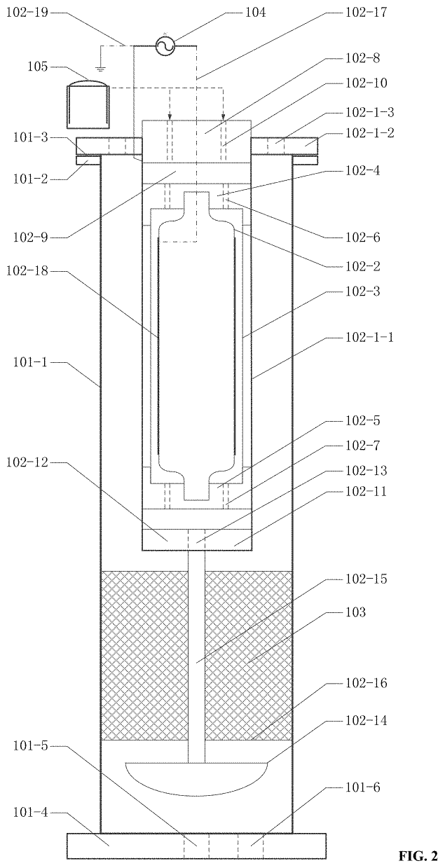

The discharge-catalysis reactor 102 comprises a reactor fixing frame, a discharge tube 102-2, a dielectric tube 102-3, an upper fixing plate 102-4, a lower fixing plate 102-5, an upper fixing plate gas hole 102-6, a lower fixing plate gas hole 102-7, an inlet gas chamber top cover 102-8, an inlet gas chamber 102-9, an inlet gas chamber top cover gas hole 102-10, an outlet gas chamber bottom cover 102-11, an outlet gas chamber 102-12, an outlet gas chamber bottom cover gas hole 102-13, an aeration plate 102-14, a stainless steel connecting pipe 102-15, a catalyst supporting net 102-16, a high-voltage wire 102-17, a conductive layer 102-18 and an earth wire 102-19. The reactor fixing frame is provided with a coaxial stainless steel round pipe 102-1-1 that is made of 316^{#} stainless steel and has a length of 120 cm, an outer diameter of 12 cm, and a wall thickness of 0.5 cm; the wall of the middle part of the coaxial stainless steel round tube 102-1-1 that is 15 cm away from the upper and lower ends of the coaxial stainless steel round tube 102-1-1 is hollowed out, with a hollow out rate of 80%; the inner walls of the upper and lower ends of the coaxial stainless steel round tube 102-1-1 are respectively lathed with internal threads with a length of 15 cm; the upper end of the coaxial stainless steel round tube 102-1-1 is provided with a stainless steel fixing frame flange 102-1-2 for fixing the reactor fixing frame in the reaction tank 101, and the stainless steel fixing frame flange 102-1-2 is provided with two water discharge holes 102-1-3; the discharge tube 102-2 is a coaxial quartz glass round tube with a thick middle and two thin ends, with a total length of 100 cm, a wall thickness of 0.3 cm, an outer diameter of 6 cm at both ends, each of which has a length of 15 cm, an outer diameter of 10 cm in the middle that has a length of 70 cm, and the outer wall of the middle part of the discharge tube 102-2 is coated with a conductive layer 102-18 with a thickness of 0.01 cm; the dielectric tube 102-3 is a coaxial quartz glass round tube, with a length of 95 cm, an inner diameter of 10.3 cm, and a wall thickness of 0.3 cm. As shown in FIGS. 2, 3, 4 and 5, the discharge tube 102-2 and the dielectric tube 102-3 are fixed within the coaxial stainless steel round tube 102-1-1 of the reactor fixing frame by the upper fixing plate 102-4 and the lower fixing plate 102-5, and the discharge tube 102-2, the dielectric tube 102-3 and the coaxial stainless steel round tube 102-1-1 are kept coaxial, and a gas gap between the outer wall of the middle part of the discharge tube 102-2 and the inner wall of the dielectric tube 102-3 has a distance of 0.3 cm; the upper fixing plate 102-4 and the lower fixing plate 102-5 are respectively provided with eight upper fixing plate gas holes 102-6 and lower fixing plate gas holes 102-7, for introducing gas into the gas gap between the discharge tube 102-2 and the dielectric tube 102-3; the cylindrical inlet gas chamber top cover 102-8 is secured to the upper end of the coaxial stainless steel round tube 102-1-1 of the reactor fixing frame via a thread on the outer wall of the cylindrical inlet chamber top cover 102-8, and an inlet gas chamber 102-9 is formed between the cylindrical inlet gas chamber top cover 102-8 and the upper fixing plate 102-4, and the inlet gas chamber top cover 102-8 is provided with four inlet gas chamber top cover gas holes 102-10 for introducing gas into the inlet gas chamber 102-9; the cylindrical outlet gas chamber bottom cover 102-11 is secured to the lower end of the coaxial stainless steel round tube 102-1-1 of the reactor fixing frame via a thread on the outer wall of the cylindrical outlet gas chamber bottom cover 102-11, and an outlet gas chamber 102-12 is formed between the cylindrical outlet gas chamber bottom cover 102-11 and the lower fixing plate 102-5, and the outlet gas chamber is provided with one outlet gas chamber bottom cover gas hole 102-13 for introducing gas into the aeration plate 102-14; the outlet gas chamber bottom cover gas hole 102-13 is communicated with the aeration plate 102-14 through a stainless steel connecting pipe 102-15, which has an outer diameter of 2.5 cm and a length of 50 cm; the catalyst supporting net 102-16 is a hollowed out coaxial cylindrical barrel with an inner diameter of 2.5 cm, an outer diameter of 26 cm, and a height of 30 cm and is fixed between the stainless steel connecting pipe 102-15 that is 5 cm above the aeration plate 102-14 and the inner wall of the reaction tank 101; the aeration plate 102-14 is hemispherical and made of microporous titanium, and has a diameter of 15 cm and a micropore aperture of 0.22-100 μm; one end of the high-voltage wire 102-17 is connected to the conductive layer 102-18 on the outer wall of the discharge tube 102-2 through the inlet gas chamber top cover 102-8, the inlet gas chamber 102-9 and the upper fixed plate 102-4 in sequence, and the other end of the high-voltage wire 102-17 is connected with the high-voltage output end of the high-voltage power supply 104; one end of the earth wire 102-19 is simultaneously connected with the coaxial stainless steel round tube 102-1-1 and the low-voltage output end of the high-voltage power supply 104, and the other end of the earth wire 102-19 is grounded.

The catalyst supporting net 102-16 is filled with 3 kg of catalyst 103, which is purchased from Shandong Shanruo Environmental Protection Sci-tech Co., Ltd., China.

The high-voltage power supply 104 is an alternating-current power supply, which has an output frequency of 6 kHz, and an adjustable output voltage of 0-20 kV, and is purchased from Dalian Yijia Ocean Sci-tech Co., Ltd China.

The gas source 105 is a liquid oxygen with a gas pressure of 0.04 MPa and a gas flow rate of 1 m³/h.

The gas-liquid separation tank 106 is a cylindrical stainless steel tank with an inner diameter of 60 cm and a height of 150 cm.

The tail gas quencher 107 is purchased from Beijing Samsun EP Hi-Tech Co., Ltd.

The SBR-MBR biochemical treatment device 2 is integrated, and consists of an integrated SBR-MBR reaction tank 201, a submerged MBR membrane module 202, an MBR pump 203, and a sludge treatment device 204, wherein the SBR biochemical treatment process is performed in four stages of a water inlet stage, an aeration stage, a standing stage and a water discharge stage, and each stage respectively lasts for 2 h, 6 h, 1 h and 1 h.

The integrated SBR-MBR reaction tank 201 is an organic glass tank with an inner diameter of 26 cm and a height of 100 cm, and is provided with a water inlet and a sludge discharge port, and is also equipped with an SBR blower 205 and an SBR aeration plate 206; the water inlet is respectively communicated with a gas-liquid separation tank water discharge control valve and the reaction tank water discharge control valve of the integrated device of dielectric barrier discharge combined with catalyst treatment 1; the SBR blower 205 is an ACO-012 type electromagnetic oxygenation pump with a flow rate of 143 L/min, and oxygen is charged into the integrated SBR-MBR reaction tank 201 by one SBR aeration plate 206 arranged at the bottom of the integrated SBR-MBR reaction tank 201, and a dissolved oxygen in water of not less than 2 mg/L is maintained; the submerged MBR membrane module 202 is submerged in the SBR-MBR reaction tank 201, and the water discharge pipe of the submerged MBR membrane module 202 is communicated with the MBR pump 203 for discharging the water in the integrated SBR-MBR reaction tank 201, and the membrane in the submerged MBR membrane module 202 is a ceramic membrane, which is purchased from Jiangsu Xinshi Membrane Technology Co., Ltd., China.

In this embodiment, due to the small throughput of the sludge, the sludge treatment device 204 is not used.

When the system of the present disclosure is used, the operation of the process flow is realized by the manual control mode of the PLC control device 3, and the specific procedures are as follows:

S1. after a circuit, a water pipeline and a gas pipeline of the system are communicated, 3 kg of catalyst 103 is filled in the catalyst supporting net 102-16, the gas source control switch 301 and tail gas quencher control switch 302 of the PLC control device 1 are turned on in sequence, and a gas in the gas source 105 is introduced into the discharge-catalysis reactor 102 of the integrated device of dielectric barrier discharge combined with catalyst treatment 1, and then the gas is discharged into the gas-liquid separation tank 106 from the water discharge hole 102-1-3 of the reactor fixing frame through the reaction tank 101, finally discharged from an exhaust port of the gas-liquid separation tank 106, and passed through the tail gas quencher 107;

S2. the reaction tank-water inlet control valve control switch 303 and the gas-liquid separation tank-water discharge control valve control switch 304 of the PLC control device 3 are turned on, and a “pretreated and biologically treated” landfill leachate is injected at a flow rate of 50 L/h into the reaction tank 101 of the integrated device of dielectric barrier discharge combined with catalyst treatment 1;

S3. after the reaction tank 101 is fully filled with water, a high-voltage power supply control switch 305 of the PLC control device 3 is turned on, and thus the high-voltage power supply 104 inputs energy into the discharge-catalysis reactor 102, and the discharge-catalysis reactor 102 discharges, to treat the landfill leachate; at this time, a water inlet stage of the SBR biochemical treatment process starts;

S4. after the water inlet stage of the SBR biochemical treatment process is completed, a SBR blower control switch 306 of the PLC control device 3 is turned on to charge oxygen to the integrated SBR-MBR reaction tank 201 and keep the concentration of the dissolved oxygen in water at 2 mg/L or more, thus starting an aeration stage of the SBR biochemical treatment process; after the aeration stage is completed, the SBR blower control switch 306 of the PLC control device 3 is turned off, and thus a standing stage of the SBR biochemical treatment process is started; after the standing stage is completed, an MBR pump control switch 307 of the PLC control device 3 is turned on to discharge water to start a water discharge stage; after the water discharge stage is completed, the MBR pump control switch 307 of the PLC control device 3 is turned off; the water inlet stage, aeration stage, standing stage, and water discharge stage are repeatedly run, during which when the integrated SBR-MBR reaction tank 201 needs to discharge a sludge, the SBR sludge discharge pump control switch 308 of the PLC control device 3 is turned on to discharge the sludge, and after the sludge is discharged completely, the SBR sludge discharge pump control switch 308 of the PLC control device 3 is turned off.

This example was carried out in a landfill leachate treatment plant in a certain city of a certain province. A raw landfill leachate was introduced to the system according to the present disclosure after being treated by a “pretreatment+biochemical treatment” process. As shown in Table 1, among the main water quality indexes before entering the system according to the present disclosure, the chromaticity, COD_{Cr}, ammonia nitrogen, total nitrogen, total phosphorus and the number of fecal coliform are higher than the emission standard specified in “Standard for Pollution Control on the Landfill Site of Municipal Solid Waste” (GB 16889-2008); in particular, the chromaticity and COD_{Cr} are much higher than the emission standard, and other water quality indexes, such as suspended solids and heavy metals, are all lower than the emission standard. After the whole process ran stably, discharged water samples were collected regularly for analysis, and their specific main indexes were shown in Table 1.

TABLE 1
Main water quality indexes before and after treated
by using the system of the present disclosure.

| | Inlet | Outlet- | |
|---|---|---|---|
| | water | water | Control |
| Main water quality indexes | sample | sample | standard |
| Chromaticity (dilution multiple) | 100 | 10 | 40 |
| COD_{Cr} (mg/L) | 943 | 85 | 100 |
| BOD₃ (mg/L) | 44 | 28 | 30 |
| Suspended solids (mg/L) | 28.4 | 9.6 | 30 |
| Total nitrogen/ammonia | 102.8/84.7 | 34.2/20.6 | 40/25 |
| nitrogen (mg/L) | | | |
| Total phosphorus (mg/L) | 14.8 | 1.0 | 3 |
| Fecal coliform (number/L) | 50000 | 1000 | 10000 |
| Total mercury, cadmium, | Not | Not | 0.001/ |
| arsenic, lead (mg/L) | detected | detected | 0.01/0.1 |
| Total chromium (mg/L) | 0.0941 | 0.0488 | 0.1 |

It can be seen from Table 1 that the main water quality indexes of the landfill leachate before entering the system are all higher than the emission standard, and after the treated by using the system, the main water quality indexes are lower than the emission standard, and the quality of the discharged water is very stable. It can be seen from this example that for the system a concentrated liquid is not generated, which effectively solves the technical defect of the “double-membrane” treatment of the landfill leachate, thereby achieving the discharge of the landfill leachate that is totally up to standard, and having the advantages of simple in operation and management, small in investment and low in operation cost, and thus the system could replace the “double-membrane” in the current “deep treatment” process.

In the description of the present disclosure, unless otherwise specified, “a plurality of” means two or more; the terms “under”, “below”, “left”, “right”, “inside”, “outside”, “front end”, “back end”, “head” and “tail” indicate the orientation or positional relationship based on the orientation or positional relationship shown in the figures, which is only for convenience of describing the present disclosure and simplifying the description, but does not indicate or imply that the referred devices or elements must be in a specific orientation, be constructed and operated in a specific orientation, and therefore it could not be understood as a limitation of the present disclosure. In addition, the terms “first”, “second”, “third” and the like are used for descriptive purposes only and could not be understood as indicating or implying relative importance.

1. A system for total volume treatment of landfill leachate, comprising an integrated device of dielectric barrier discharge combined with catalyst treatment, an SBR-MBR biochemical treatment device and a PLC control device, wherein
the integrated device of dielectric barrier discharge combined with catalyst treatment is communicated with the SBR-MBR biochemical treatment device through a water transport pipeline, and the PLC control device is respectively connected with the integrated device of dielectric barrier discharge combined with catalyst treatment and the SBR-MBR biochemical treatment device through connecting lines.

2. The system for total volume treatment of landfill leachate as claimed in claim 1, wherein the integrated device of dielectric barrier discharge combined with catalyst treatment is provided with a reaction tank, wherein the reaction tank is internally provided with a discharge-catalysis reactor and a catalyst supporting net filled with a catalyst below the discharge-catalysis reactor, and is communicated with a gas-liquid separation tank through a water transport pipeline, wherein the gas-liquid separation tank is communicated with a tail gas quencher through a gas transport pipeline;
the discharge-catalysis reactor is communicated with a gas source through a gas transport pipeline, and the gas source is communicated with the PLC control device through a connecting line; and
the discharge-catalysis reactor is connected with a high-voltage power supply through a connecting line, and the high-voltage power supply is connected with the PLC control device through a connecting line.

3. The system for total volume treatment of landfill leachate as claimed in claim 2, wherein the reaction tank comprises a reaction tank body, a reaction tank body flange, a flange silica gel pad and a reaction tank base, wherein the reaction tank body flange is mounted at the upper end of the reaction tank body, and is padded with the flange silica gel pad thereon; the lower end of the reaction tank body is fixed on the reaction tank base, and the reaction tank base is arranged with a water inlet and a water outlet at the center, wherein the water inlet and the water outlet are respectively provided with a reaction tank water inlet control valve and a reaction tank water outlet control valve.

4. The system for total volume treatment of landfill leachate as claimed in claim 2, wherein the discharge-catalysis reactor is provided with a reactor fixing frame, wherein the reactor fixing frame is provided with a coaxial stainless steel round pipe and a stainless steel fixing frame flange installed at the upper end of the coaxial stainless steel round pipe, for fixing the discharge-catalysis reactor in the reaction tank body, and the surface of the stainless steel fixing frame flange is provided with a water discharge hole;
the upper end and the lower end of the coaxial stainless steel round pipe are respectively provided with an upper fixing plate and a lower fixing plate, which are respectively threadably secured thereon, and a discharge tube is sandwiched between the upper fixing plate and the lower fixing plate, and is sheathed with a dielectric tube at the outside of the discharge tube; and
the upper fixing plate and the lower fixing plate are respectively provided with an upper fixing plate gas hole and a lower fixing plate gas hole, and the upper fixing plate gas hole and the lower fixing plate gas hole are communicated with the gap between the discharge tube and the dielectric tube.

5. The system for total volume treatment of landfill leachate as claimed in claim 4, wherein the upper end inside the coaxial stainless steel round pipe is provided with an inlet gas chamber top cover which is threadably secured, and an inlet gas chamber is sandwiched between the inlet gas chamber top cover and the upper fixing plate; the inlet gas chamber top cover is provided with an inlet gas chamber top cover gas hole, and the inlet gas chamber top cover gas hole is communicated with the gas source through a gas transport pipeline; and
the lower end inside the coaxial stainless steel round pipe is provided with an outlet gas chamber bottom cover which is threadably secured, and an outlet gas chamber is sandwiched between the outlet gas chamber bottom cover and the lower fixing plate; the outlet gas chamber bottom cover is provided with an outlet gas chamber bottom cover gas hole, and the lower end of the outlet gas chamber bottom cover gas hole is communicated with an aeration plate through a stainless steel connecting pipe, wherein the aeration plate is under the catalyst supporting net.

6. The system for total volume treatment of landfill leachate as claimed in claim 1, wherein the SBR-MBR biochemical treatment device is an integrated SBR-MBR biochemical treatment device, which comprises an integrated SBR-MBR reaction tank, a submerged MBR membrane module, an MBR pump and a sludge treatment device, wherein
the integrated SBR-MBR reaction tank is provided with a water inlet and a sludge discharge port, and also equipped with an SBR blower, an SBR aeration plate and an SBR sludge discharge pump;
the water inlet of the integrated SBR-MBR reaction tank is respectively communicated with a gas-liquid separation tank water discharge control valve and a reaction tank water discharge control valve of the integrated device for a discharge barriered by dielectric and a catalysis treatment; the SBR blower is to charge oxygen into the integrated SBR-MBR reaction tank through the SBR aeration plate arranged at the bottom of the integrated SBR-MBR reaction tank, and the SBR sludge discharge pump is communicated with the sludge discharge port of the integrated SBR-MBR reaction tank;
the submerged MBR membrane module is submerged in the integrated SBR-MBR reaction tank, and a water discharge pipeline of the submerged MBR membrane module is communicated with the MBR pump; and
the sludge treatment device is provided with a sludge tank, a dosing tank, a stirrer and a pressure filter; the sludge tank is provided with a sludge inlet, a dosing port and a sludge discharge port, wherein the sludge inlet is communicated with the SBR sludge discharge pump, the dosing port is communicated with the dosing tank, the stirrer is located in the sludge tank, and the sludge discharge port is communicated with the pressure filter.

7. A system for total volume treatment of landfill leachate as claimed in claim 1, wherein the SBR-MBR biochemical treatment device is a split SBR-MBR biochemical treatment device, which comprises an SBR reaction tank, a MBR pump, an external MBR membrane module and a sludge treatment device;
the SBR reaction tank is provided with an SBR water inlet and an SBR sludge discharge port, and also equipped with an SBR blower, an SBR aeration plate, an SBR water decanter and an SBR sludge discharge pump;
the SBR water inlet is respectively communicated with a gas-liquid separation tank water discharge control valve and a reaction tank water discharge control valve of the integrated device of dielectric barrier discharge combined with catalyst treatment; the SBR blower is to charge oxygen into the SBR reaction tank through the SBR aeration plate arranged at the bottom of the SBR reaction tank; the SBR water decanter is installed in the SBR reaction tank, and its water outlet is sequentially communicated with the MBR pump and the external MBR membrane module through a water transport pipeline; the SBR sludge discharge port is sequentially communicated with the SBR sludge discharge pump and the sludge treatment device through a sludge discharge pipeline.

8. The system for total volume treatment of landfill leachate as claimed in claim 1, wherein the PLC control device comprises outside a gas source control switch, a tail gas quencher control switch, a reaction tank-water inlet control valve control switch, a gas-liquid separation tank-water discharge control valve control switch, a high-voltage power supply control switch, an SBR blower control switch, an MBR pump control switch, an SBR sludge discharge pump control switch, a sludge treatment device control switch and a reaction tank-water discharge control valve control switch.

9. A method for totally treating landfill leachate by using the system for total volume treatment of landfill leachate as claimed in claim 1, comprising:
(1) after a connecting line, a water transport pipeline and a gas transport pipeline of the system, and filling the catalyst supporting net with a catalyst, turning on the gas source control switch and tail gas quencher control switch of the PLC control device in sequence, and introducing a gas in the gas source into the discharge-catalysis reactor of the integrated device of dielectric barrier discharge combined with catalyst treatment, discharging the gas into the gas-liquid separation tank from the water discharge hole of the reactor fixing frame through the reaction tank, and finally discharging the gas from an exhaust port of the gas-liquid separation tank and passing the gas through the tail gas quencher;
(2) turning on the reaction tank-water inlet control valve control switch and the gas-liquid separation tank-water discharge control valve control switch of the PLC control device, and injecting a pretreated and biologically treated landfill leachate into the reaction tank of the integrated device of dielectric barrier discharge combined with catalyst treatment;
(3) after filling the reaction tank with water, turning on the high-voltage power supply control switch of the PLC control device, inputting energy into the discharge-catalysis reactor by the high-voltage power supply, and performing a discharge in the discharge-catalysis reactor to treat landfill leachate, while performing a water inlet stage of the SBR biochemical treatment; and
(4) after the water inlet stage of the SBR biochemical treatment process is completed, turning on the SBR blower control switch of the PLC control device to charge oxygen to the integrated SBR-MBR reaction tank or the split SBR reaction tank to start an aeration stage of the SBR biochemical treatment process; after the aeration stage is completed, turning off the SBR blower control switch of the PLC control device to start a standing stage of the SBR biochemical treatment process; after the standing stage is completed, turning on the MBR pump control switch of the PLC control device to discharge water to start a water discharge stage; after the water discharge stage is completed, turning off the MBR pump control switch of the PLC control device; repeatedly running the water inlet stage, aeration stage, standing stage, and water discharge stage of the SBR biochemical treatment, during which when a sludge discharge is needed, turning on the SBR sludge discharge pump control switch of the PLC control device to discharge the sludge, and after the sludge is discharged completely, turning off the SBR sludge discharge pump control switch of the PLC control device.

10. A method for treating landfill leachate, comprising
using the system for total volume treatment of landfill leachate as claimed in claim 1.

11. The system for total volume treatment of landfill leachate as claimed in claim 2, wherein the PLC control device comprises outside a gas source control switch, a tail gas quencher control switch, a reaction tank-water inlet control valve control switch, a gas-liquid separation tank-water discharge control valve control switch, a high-voltage power supply control switch, an SBR blower control switch, an MBR pump control switch, an SBR sludge discharge pump control switch, a sludge treatment device control switch and a reaction tank-water discharge control valve control switch.

12. The system for total volume treatment of landfill leachate as claimed in claim 3, wherein the PLC control device comprises outside a gas source control switch, a tail gas quencher control switch, a reaction tank-water inlet control valve control switch, a gas-liquid separation tank-water discharge control valve control switch, a high-voltage power supply control switch, an SBR blower control switch, an MBR pump control switch, an SBR sludge discharge pump control switch, a sludge treatment device control switch and a reaction tank-water discharge control valve control switch.

13. The system for total volume treatment of landfill leachate as claimed in claim 4, wherein the PLC control device comprises outside a gas source control switch, a tail gas quencher control switch, a reaction tank-water inlet control valve control switch, a gas-liquid separation tank-water discharge control valve control switch, a high-voltage power supply control switch, an SBR blower control switch, an MBR pump control switch, an SBR sludge discharge pump control switch, a sludge treatment device control switch and a reaction tank-water discharge control valve control switch.

14. The system for total volume treatment of landfill leachate as claimed in claim 5, wherein the PLC control device comprises outside a gas source control switch, a tail gas quencher control switch, a reaction tank-water inlet control valve control switch, a gas-liquid separation tank-water discharge control valve control switch, a high-voltage power supply control switch, an SBR blower control switch, an MBR pump control switch, an SBR sludge discharge pump control switch, a sludge treatment device control switch and a reaction tank-water discharge control valve control switch.

15. The system for total volume treatment of landfill leachate as claimed in claim 6, wherein the PLC control device comprises outside a gas source control switch, a tail gas quencher control switch, a reaction tank-water inlet control valve control switch, a gas-liquid separation tank-water discharge control valve control switch, a high-voltage power supply control switch, an SBR blower control switch, an MBR pump control switch, an SBR sludge discharge pump control switch, a sludge treatment device control switch and a reaction tank-water discharge control valve control switch.

16. The system for total volume treatment of landfill leachate as claimed in claim 7, wherein the PLC control device comprises outside a gas source control switch, a tail gas quencher control switch, a reaction tank-water inlet control valve control switch, a gas-liquid separation tank-water discharge control valve control switch, a high-voltage power supply control switch, an SBR blower control switch, an MBR pump control switch, an SBR sludge discharge pump control switch, a sludge treatment device control switch and a reaction tank-water discharge control valve control switch.
